(19) United States
(12) Patent Application Publication
(10) Pub. No.: US 2006/0093708 A1
(43) Pub. Date: May 4, 2006

(54) Ice cream novelty product

(75) Inventors: Louis G. Yaseen, Clyde Hill, WA (US); Linda L. Yaseen, Clyde Hill, WA (US)

Correspondence Address: JENSEN + PUNTIGAM, P.S., SUITE 1020, 2033 6TH AVE, SEATTLE, WA, 98121, US

(73) Assignee: Cold Standard, Inc.

(21) Appl. No.: 10/982,940

(22) Filed: Nov. 4, 2004

(51) Int. Cl. A23G 9/00

(52) U.S. Cl. 426/101

(57) ABSTRACT

The ice cream novelty product and the method of manufacturing the product includes two relatively thin layers of biscotti baked goods, approximately ¼-inch thick, on opposing surfaces of an intermediate ice cream layer, approximately ¾-inch thick. On the surface of each biscotti layer which comes into contact with the ice cream layer is a layer of thin, couverture chocolate. The chocolate layers are quite thin, approximately 1/16- 1/32 inch, with the couverture chocolate being a combination of chocolate liquor and cocoa butter in the range of 33-36% cocoa butter, with the rest being substantially chocolate liquor.

### TECHNICAL FIELD

This invention relates generally to an ice cream novelty product, and more particularly concerns such a product which includes a cookie/wafer portion.

### BACKGROUND OF THE INVENTION

Ice cream novelty products of various arrangements and ingredients are well known. These include the product known commercially as an ice cream sandwich, which comprises an intermediate layer of ice cream, which is generally, but not always, an inexpensive ice cream or ice milk, with thin, soft cookie or wafer members abutting the opposing sides of the ice cream layer, forming a sandwich-like product, which users eat with their hands.

While the traditional ice cream sandwich product has been popular over an extended period of time, it does have some disadvantages, including generally low quality and taste. Further, the cookie portions often quickly become too soft due to the accumulation of moisture migrating from the ice cream between the time of manufacture and consumption.

The new ice cream novelty product shown and described herein is similar in general concept to the traditional ice cream sandwich, but is significantly improved in several ways, resulting in a substantially new product, as disclosed below.

### SUMMARY OF THE INVENTION

Accordingly, the present invention is an ice cream novelty product, comprising: a layer of ice cream; first and second layers of biscotti positioned on opposing sides of the ice cream layer; and a layer of chocolate on the surfaces of the biscotti layers, respectively, which are adjacent to and come into contact with the ice cream layer.

### BRIEF DESCRIPTION OF THE DRAWINGS

FIG. 1 is an isometric view of the ice cream novelty product disclosed herein.

FIG. 2 is a cross-sectional view of the product of FIG. 1.

FIG. 3 shows a sequence of steps in the manufacture of the product of FIGS. 1 and 2.

### BEST MODE FOR CARRYING OUT THE INVENTION

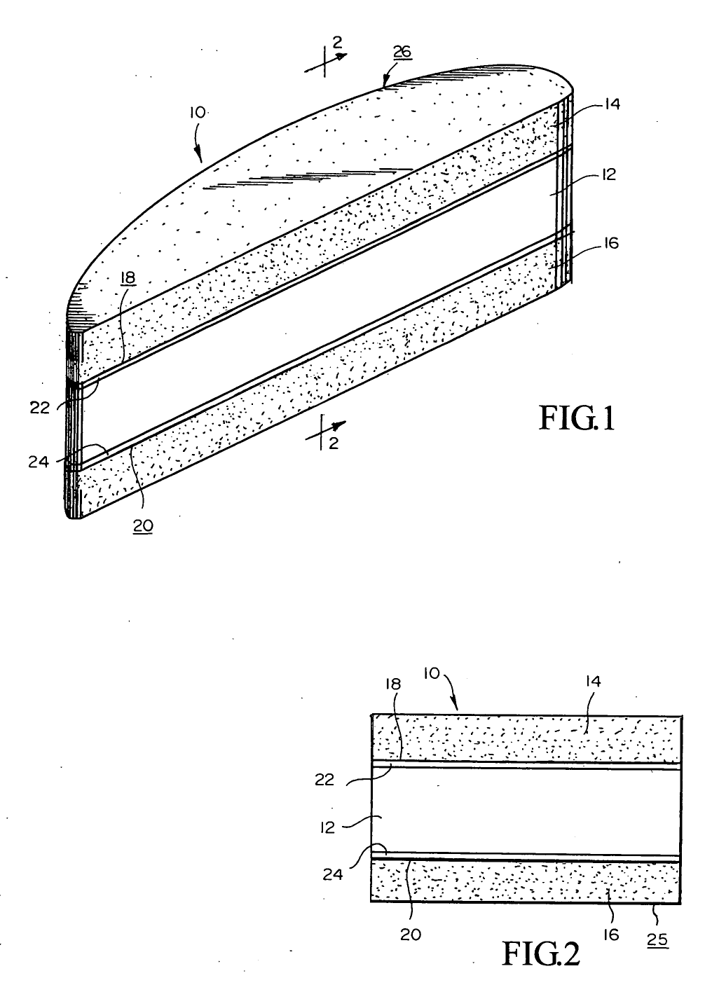

FIGS. 1 and 2 show an embodiment of the new ice cream novelty product, generally at 10. The ice cream product 10 comprises an intermediate layer 12 of ice cream and two outside cookie layers 14, 16 which abut opposing surfaces of the ice cream layer 12. In the embodiment shown, the outside cookie layers 14 and 16 are biscotti. The term “biscotti” refers to a dry, hard, twice-baked cookie. The biscotti layers 14, 16 are relatively thin compared to the thickness of the ice cream layer 12, so that the ice cream product is convenient to eat, like a sandwich. The thin biscotti layers make the sandwich easier to bite, thus making it less likely that the intermediate ice cream will be squeezed out the sides of the sandwich under pressure exerted by the teeth and jaw when the ice cream is not hard frozen.

On the interior surfaces 18, 20 of biscotti layers 14, 16, respectively, facing ice cream layer 12, are thin layers of chocolate 22, 24. The chocolate layers 22, 24 come into contact with the ice cream and form a moisture barrier between ice cream layer 12 and biscotti layers 14 and 16, respectively, as well as strengthening the biscotti layers, preserving the structural integrity of the biscotti during eating of the product, which is normally quite fragile, i.e. crumbly, due to its dry, twice-baked character. The biscotti layers remain crisp and dry, without cracking or crumbling, during eating of the sandwich. Hence, the chocolate layers are an important structural element of the ice cream product. The end product is convenient to eat, delicious, and does not crumble during eating.

Now, in more detail, the ice cream layer 12 will typically be ⅝-1 inch, preferably ¾ inch. The ice cream may, of course, be a wide variety of flavors and could be inexpensive ice cream, like the traditional ice cream sandwich, although a high quality ice cream is generally preferred for the present product. Such a high quality product complements the increasing popularity and acceptance of high quality, expensive and specialty ice creams. The butterfat content will typically be greater than 10%, but not more than 18%, with a preferred range of 14-16%. However, it should be understood that a high quality ice cream is not necessary to the present invention. Other ice creams, including ice milk products, could be used. Also, it would be possible to use frozen yogurt, sorbet, sherbet and/or gelati.

Normal biscotti cookies typically have a thickness of approximately ⅝-1 inch. The biscotti cookie layers 14 and 16 range in thickness from ⅛ inch to ½ inch, with a preferred thickness of approximately ¼ inch. The configuration of the biscotti cookie will be generally the traditional biscotti shape, with a flat bottom surface 25 and a somewhat curved upper surface 26. Biscotti cookies are typically cut from a loaf, giving the biscotti its traditional shape, as shown in FIG. 1. The biscotti layers could have other configurations, including a rectangular outline within a range of 4 inches to 5-¾ inches long and 1-¼ to 1-½ inches wide (tall) . Preferably, the cookie layers are 4-⅜ inches long and 1-⅜ inches wide (or its widest dimension), either with traditional or rectangular configuration. The length and width of the biscotti layers can certainly be varied, although the thickness dimension, particularly the total thickness of the ice cream layer and the two biscotti layers, must be controlled to provide good taste, texture (in the mouth) and convenience in eating.

After baking, the biscotti will typically have a moisture content within the range of 6-8% and a butterfat content within the range of 10-15% of the dough weight. This results in a dry biscotti, with a desired amount of crumble, and which can be readily bitten into. When the product is in its frozen, ready-to-eat form, a good crumble is important so that the eater is aware that the product is easy to eat. The butterfat content may also be a deterrent to moisture.

Traditional biscotti often has an almond flavor, but it should be understood that the biscotti layers 14, 16 in the present embodiment can have a variety of flavors as well as contain additional elements, including dried fruits, bits of chocolate, and various varieties of nuts, seeds and spices. The invention is not limited to selected flavor or taste characteristics of the biscotti, other than that it should preferably be a traditional biscotti in terms of texture and dryness.

The chocolate layers 22 and 24 are generally less than ⅛-inch thick, with an ideal thickness of between 1/16 inch and 1/32 inch. Preferably, the chocolate comprising the layers is a dark chocolate, a particular combination of cocoa butter and chocolate liquor, referred to generally as couverture chocolate. The chocolate could, however, be milk or white chocolate. In the embodiment described, it is 33-36% cocoa butter and 64-67% chocolate liquor, although this can be varied, e.g. the chocolate liquor may be increased up to 72%. Couverture chocolate is generally used in more expensive chocolate items for dipping, coating, molding and garnishing. It provides a smooth, thin coating which has the advantages of providing structural integrity to the dry, rather crumbly biscotti layers while also providing a moisture barrier between the ice cream and the biscotti layers, preventing the biscotti layers from softening and preserving their crispness (crunch). The preferred couverture chocolate is contrasted with compound coating chocolate, which contains vegetable oil, although such chocolate can also be used in the present product.

The combination of the ice cream layer, the thin, crisp biscotti layers and the very thin chocolate layers produces an ice cream sandwich product which is both attractive and good tasting, with good flavor and texture, and further is comfortable to eat.

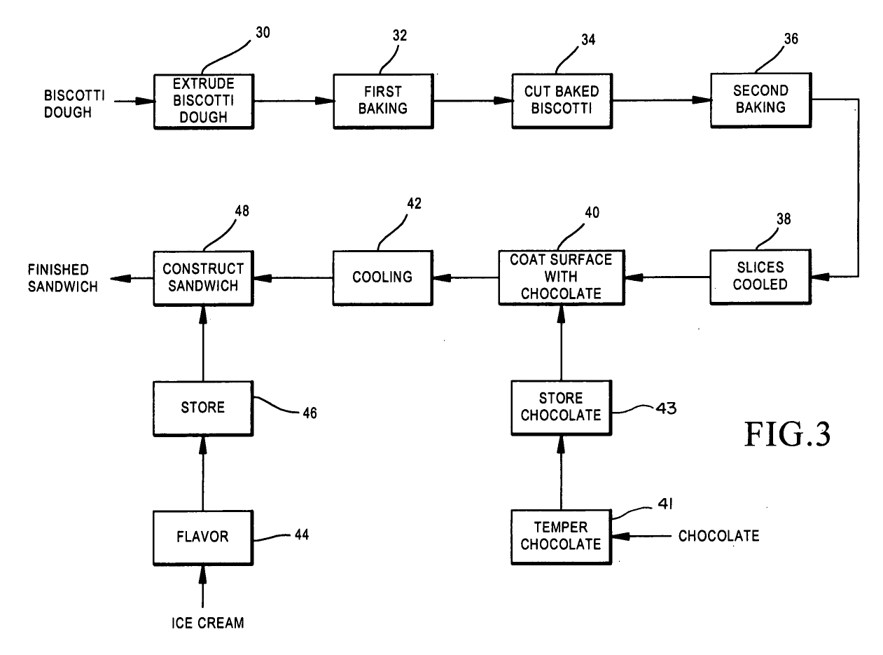

The ice cream product 10 is manufactured in accordance with the following steps, referring to FIG. 3.

First, biscotti dough is dumped into an extruder which deposits or lays down a plurality of continuous lines of dough, each in the shape of a loaf, on a continuous steel band (step 30). In the embodiment shown, there are six to eight such continuous lines of dough.

The steel band moves the lines of dough loaves into a 30-foot conventional “continuous band” oven, using indirect heating at 350° F., for a first baking step (step 32), which lasts approximately 22 minutes. The first-baked biscotti lines of dough loaves are then cut longitudinally by an ultrasonic knife or a high pressure water knife into ¼-inch thick slices (step 34), which then topple over flat on a continuous steel mesh conveyor, which moves the biscotti to a 60-foot oven for a second baking step (step 36).

The twice-baked ¼-inch biscotti slices are then cooled to room temperature (step 38) and are then moved by the mesh conveyor through a chocolate bottoming tank, which coats the lower surface of the biscotti layers (step 40). After leaving the bottoming tank station, the chocolate-coated biscotti pass over a 0° F. cooling plate to cool and harden the chocolate layer (step 42).

The chocolate for the chocolate layer in the embodiment shown typically comes in either large (11-pound) blocks or small pieces. The chocolate is melted and tempered, a step in which the liquid chocolate is heated to about 120° F., allowed to cool to about 80° F. and then heated up again to 90° F. (step 41). The tempered chocolate is stored (step 43) in a holding tank, where it is constantly stirred and then pumped through heated pipes to the chocolate bottoming station (step 40).

The ice cream for the intermediate layer is made conventionally using pre-mixed totes of ice cream, which for example are each approximately 250 pounds. The totes are dumped into flavor tanks, where flavoring is added (step 44). The mix is pumped into continuous ice cream freezers for freezing. The ice cream is pumped from the freezers through jacketed piping to the work station where the actual sandwich is constructed.

The chocolate-coated biscotti layers are delivered to a cooling room within the ice cream production area for construction of the sandwich (step 48). Within the ice cream production area, the biscotti are automatically (or manually) transferred to a pre-set position on a moving plate. At the same time, ice cream is vertically extruded, sliced to the desired thickness by, for instance, a moving hot wire, and deposited on top of a first layer of biscotti. The top layer of biscotti is then positioned on top of the ice cream layer and the finished product enters a −45° F. hardening tunnel for about 15 minutes. The completed sandwiches then proceed into a wrapping machine station, where they are wrapped, collected, cartoned and hand-packed into shipping boxes.

Accordingly, a new ice cream product, in the form of an ice cream sandwich, has been disclosed, as well as a particular method of manufacturing the product.

Although a preferred embodiment of the invention has been disclosed for purposes of illustration, it should be understood that various changes, modifications and substitutions may be incorporated in the embodiment without departing from the spirit of the invention which is defined by the claims which follow.

What is claimed is:

1. An ice cream novelty product, comprising:
a layer of ice cream;
first and second layers of biscotti positioned on opposing sides of the ice cream layer; and
a layer of chocolate on the surfaces of the biscotti layers, respectively, which are adjacent to and come into contact with the ice cream layer.

2. The ice cream novelty product of claim 1, wherein the chocolate is a dark chocolate.

3. The ice cream novelty product of claim 1, wherein the thickness of each biscotti layer is in the range of ⅛ inch to ½ inch, the thickness of the ice cream layer is less than 1 inch, and the thickness of the chocolate layer on each biscotti layer is less than ⅛ inch, with a minimum of 1/32 inch.

4. The ice cream novelty product of claim 1, wherein the biscotti layers have a thickness of approximately ¼ inch, the ice cream layer has a thickness of approximately ¾ inch, and the chocolate layers on the biscotti have a thickness of approximately 1/16- 1/32 inch.

5. The ice cream novelty product of claim 1, wherein the biscotti layers are approximately 4-⅜ inches long, 1-⅜ inches wide at their widest dimension and approximately ¼ inch thick.

6. The ice cream novelty product of claim 1, wherein the chocolate layers comprise couverture chocolate.

7. The ice cream novelty product of claim 6, wherein the chocolate is approximately within the range of 63%-72% chocolate liquor, with the remainder being cocoa butter.

8. The ice cream novelty product of claim 1, wherein the chocolate is milk chocolate.

9. The ice cream novelty product of claim 1, wherein the chocolate is white chocolate.

10. The ice cream novelty product of claim 1, wherein the biscotti has a moisture content in the range of 6%-8% and has a butterfat content of approximately 10-15% of the weight of the biscotti dough.

11. A method of manufacturing an ice cream novelty product, comprising the steps of:
forming biscotti baked-goods members having a thickness in the range of ⅛ inch to ½ inch;
coating at least one surface of each biscotti member with a thin layer of chocolate;
forming a layer of ice cream; and
applying coated biscotti members to opposing surfaces of the ice cream layer, with the chocolate surface of the biscotti members against the ice cream layer, thereby forming an ice cream sandwich product.

12. The method of claim 11, wherein the chocolate is a couverture chocolate having cocoa butter in the range of 28%-39%, with the remainder being substantially chocolate liquor.

13. The method of claim 11, wherein the thickness of each biscotti member portion is ¼ inch, the thickness of the chocolate on the biscotti is in the range of 1/16- 1/32 inch, and the ice cream layer is approximately ¾ inch thick.

14. The method of claim 11, wherein the biscotti members are formed from biscotti dough which has been initially baked, sliced into the desired thickness and then baked again to a moisture content of between 6% and 8%.

15. The method of claim 14, wherein the sliced and twice-baked biscotti members are cooled to room temperature and then passed by a conveyor over a chocolate tank for coating with the chocolate, and wherein the chocolate is tempered prior to coating the biscotti members.
